(19) United States
(12) Patent Application Publication
(10) Pub. No.: US 2004/0107319 A1
(43) Pub. Date: Jun. 3, 2004

(54) Cache management system and method

(76) Inventors: David M. D'Orto, Cherry Hill, NJ (US); Neil Kenig, Mt. Laurel, NJ (US); Peter H. Petersen, Trenton, NJ (US); Gregory Pavlik, Shamong, NJ (US)

Correspondence Address: HEWLETT-PACKARD COMPANY, Intellectual Property Administration, P.O. Box 272400, Fort Collins, CO, 80527-2400, US

(21) Appl. No.: 10/308,459

(22) Filed: Dec. 3, 2002

(51) Int. Cl. G06F 12/12

(52) U.S. Cl. 711/133; 711/135

(57) ABSTRACT

A cache management system comprises a cache adapted store data corresponding to a data source. The cache management system also comprises a cache manager adapted to access a set of rules to determine a frequency for automatically updating the data in the cache. The cache manager is also adapted to automatically communicate with the data source to update the data in the cache corresponding to the determined frequency.

### TECHNICAL FIELD OF THE INVENTION

The present invention relates generally to the field of computer systems and, more particularly, to a cache management system and method.

### BACKGROUND OF THE INVENTION

Computer systems generally include a cache for temporarily storing information to increase operating efficiency of the computer systems. For example, in an Internet application, information associated with a web site or other data source may be stored in the cache such that, in response to a future request for the information, the cache may be accessed to retrieve the information instead of requiring repeated downloading of the information from the Internet web site. In operation, in response to requesting the information, a comparison is made between content stored in the cache and the information from the web site. If the content from the web site has not changed or been updated, the information stored in the cache is provided.

However, the effectiveness of cache data storage is generally limited by the frequency of modifications to the data at the data source. For example, if information at the data source changes frequently, the information stored in the cache becomes “stale,” thereby requiring more frequent downloading of the information from the data source and resulting in an increased use of computer system resources.

### SUMMARY OF THE INVENTION

In accordance with one embodiment of the present invention, a cache management system comprises a cache adapted to store data corresponding to a data source. The cache management system also comprises a cache manager adapted to access a set of rules to determine a frequency for automatically updating the data in the cache. The cache manager is also adapted to automatically communicate with the data source to update the data in the cache corresponding to the determined frequency.

In accordance with another embodiment of the present invention, a method for cache management comprises storing data associated with a data source in a cache and accessing a set of rules to determine a frequency for automatically updating the data in the cache. The method also comprises automatically initiating communications with the data source corresponding to the determined frequency and automatically updating the data in the cache corresponding to the determined frequency.

### BRIEF DESCRIPTION OF THE DRAWINGS

For a more complete understanding of the present invention and the advantages thereof, reference is now made to the following descriptions taken in connection with the accompanying drawings in which:

FIG. 1 is a diagram illustrating an embodiment of a cache management system in accordance with the present invention;

FIG. 2 is a flow chart illustrating an embodiment of a cache management method in accordance with the present invention;

FIG. 3 is a flow chart illustrating another embodiment of a cache management method in accordance with the present invention; and

FIG. 4 is a flow chart illustrating a further embodiment of a cache management method in accordance with the present invention.

### DETAILED DESCRIPTION OF THE DRAWINGS

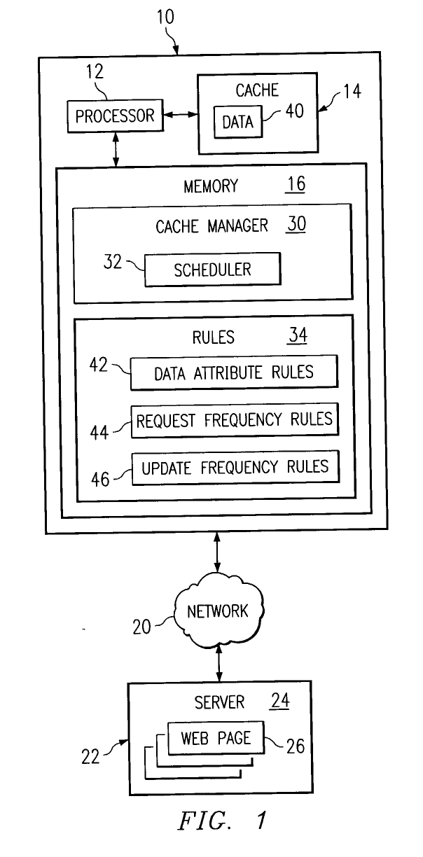

The preferred embodiments of the present invention and the advantages thereof are best understood by referring to FIGS. 1-4 of the drawings, like numerals being used for like and corresponding parts of the various drawings.

FIG. 1 is a diagram illustrating an embodiment of a cache management system 10 in accordance with the present invention. Briefly, system 10 automatically updates information stored in a cache independently of a request for the information by a user, thereby enhancing the use of system resources and increasing operating efficiency. For example, according to one embodiment of the present invention, cache management system 10 automatically updates information stored in the cache corresponding to the type of data. In another embodiment, cache management system 10 automatically updates information stored in the cache corresponding to the frequency a user accesses or requests the information. In yet another embodiment, cache management system 10 automatically updates information stored in the cache corresponding to the frequency at which the source data is updated. Thus, the present invention embodies a variety of rules to automatically update information stored in a cache to increase operating efficiency and reduce the time required to access the information.

In the illustrated embodiment, system 10 comprises a processor 12 coupled to a cache 14 and a memory 16. Cache 14 may comprise level one (L1) cache, level two (L2) cache, browser cache, proxy cache, or other cache memory corresponding to a desired caching application. In the illustrated embodiment, memory 16 comprises a main memory, such as random access memory (RAM) or other memory structures.

In the illustrated embodiment, system 10 is coupled to a communication network 20, such as the Internet, intranet, or other type of wired or wireless network. As illustrated in FIG. 1, system 10 communicates with one or more data sources 22 via communication network 20. For example, in the illustrated embodiment, a particular data source 22 may comprise a server 24 hosting one or more web pages 26 accessible via communication network 20. However, other types of information sources may also comprise data sources 22. The illustrated embodiment contemplates remotely located data sources 22 accessible by communication network 20. However, it should be understood that data sources may also be stored in memory 16.

In the embodiment of FIG. 1, system 10 also comprises a cache manager 30, a scheduler 32, and a set of rules 34. Cache manager 30, scheduler 32, and rules 34 may be stored in memory 16 where they may be accessible by processor 12. However, it should be understood that cache manager 30, scheduler 32, and rules 34 may be otherwise located or stored such that manager 30, scheduler 32, and rules 34 are accessible by processor 12. Cache manager 30, scheduler 32, and rules 34 may encompass computer software, hardware, or a combination of software and hardware that may be executed by processor 12.

Briefly, cache manager 30 monitors activities associated with requested data and/or determines various characteristics associated with the requested data to automatically update data stored in cache 14. Cache manager 30 also automatically initiates a communication link with data source 22 to obtain the updated data corresponding to a frequency determined by cache manager 30. Scheduler 32 automatically schedules the communication links with data source 22 to obtain the updated data. In FIG. 1, scheduler 32 is illustrated as part of cache manager 30. However, it should be understood that scheduler 32 may also be separately configured.

Rules 34 comprise information used by cache manager 30 to determine a frequency or schedule for updating data 40 stored in cache 14. For example, in the illustrated embodiment, rules 34 comprise data attribute rules 42, request frequency rules 44, and update frequency rules 46. Data attribute rules 42 comprise information associated with a particular type of data or attributes of the data at data source 22 indicating a frequency at which cache manager 30 may update data 40 within cache 14. For example, data source 22 may comprise information associated with weather for a particular geographic region. Data attribute rules 40 may comprise information correlating the type or attributes of data at data source 22 with a frequency at which data 40 in cache 14 should be updated. Thus, for example, if data source 22 comprises weather information, data attribute rules 42 may indicate that data 40 in cache 14 should be updated with data from data source 22 every thirty minutes. Accordingly, based on the type or attributes of information stored at data source 22, data attribute rules 42 may identify particular frequencies or time periods for updating data 40 stored in cache 14.

Request frequency rules 44 comprise information associated with correlating the frequency a user of system 10 accesses or requests information from data source 22 with a frequency for automatically updating data 40 stored in cache 14 with information from data source 22. For example, a particular user may request access to a particular web page 26 according to a regular interval, such as accessing a news-related web page 26 in the morning, at noon, and in the evening. Thus, request frequency rules 44 may comprise information identifying a particular frequency or particular time periods for automatically updating data 40 in cache 14 corresponding to the frequency of requested access to the information of data source 22. Thus, based on a frequency of user requests or access to information from data source 22, cache manager 30 automatically obtains information from data source 22 and updates data 40 stored in cache 14. Additionally, cache manager 30 may also monitor access to a particular data source 22 by one or more users, thereby automatically updating data 40 in cache 14 corresponding to the frequency of requests by multiple users.

Update frequency rules 46 comprise information associated with the frequency of updates to information at data source 22. For example, information at data source 22 may be updated on a regular basis or predetermined frequency, such as updates to stock quotes or weather reports. Thus, based on the frequency of updates to information at data source 22, cache manager 30 automatically retrieves the updated information from data source 22 and stores the information as updated data 40 within cache 14.

In operation, in response to a user request for information from a particular data source 22, processor 12 initiates communication with the requested data source 22 to retrieve the information and store the information as data 40 in cache 14. Cache manager 30 may then access one or more sets of rules 34 to determine an update frequency to replace “stale” data 40 within cache 14 with updated data 40. For example, cache manager may access data attribute rules 22 to determine the type of information retrieved from data source 22. Based on the type of data retrieved from data source 22, data attribute rules 42 may indicate a predetermined frequency of updating data 40 in cache 14. Thus, based on the update frequency indicated by data attribute rules 42, scheduler 32 may be used to automatically initiate communication with data source 22 to obtain and store updated data 40 within cache 14. Therefore, in operation, scheduler 32 automatically initiates communication with data source 22 according to the schedule or frequency determined by cache manager 30 to obtain updated data from data source 22. The obtained data is then stored in cache 14. Thus, in response to the next request by a user for the information from data source 22, the requested information may be readily and efficiently retrieved from cache 14.

Cache manager 30 may also monitor a frequency of requests for information from one or more data sources 22 over a predetermined time period for determining a frequency of obtaining updated information from data source(s) 22. For example, cache manager 30 may monitor the frequency of requests for information from a particular data source 22 for a single user or multiple users as well as the frequency of requests by a single user of multiple data sources 22. Based on the request frequency, cache manager 30 may access request frequency rules 44 to determine a frequency of automatically communicating with the data source 22 to retrieve information from data source 22 and update data 40 stored in cache 14. Thus, based on the frequency indicated by request frequency rules 44, scheduler 32 may automatically initiate communications with the data source 22 to obtain the information for updating cache 14.

Cache manager 30 may also determine a frequency of updates to information at data source 22 to determine a frequency for updating information in cache 14. For example, information at data source 22 may be updated at data source 22 according to a particular schedule. Cache manager 30 may instruct scheduler 32 to automatically initiate communication with data source 22 corresponding to a determined frequency or schedule such that “stale” data 40 within cache 14 is automatically updated with the new information as information is updated at data source 22. Cache manager 30 may also access update frequency rules 46 to determine a frequency for updating information in cache 14 based on the frequency of updates at data source 22. For example, cache manager 30 may evaluate additional rules in combination with update frequency rules 46 to determine a frequency for updating information in cache 14. Thus, even though data source 22 may be updated according to a particular schedule, cache manager 30 may determine a frequency or schedule for updating cache 14 based on the frequency of updates at data source 22 as well as the frequency of user requests for information from data source 22. Thus, cache manager may access request frequency rules 44 and update frequency rules 46 to determining the frequency for updating cache 14.

As described above, cache manager 30 may access rules 34 to determine an update schedule for information in cache 14 based on a single criteria, such as the type or attributes of the data according to data attribute rules 42, the frequency of requests for information according to request frequency rules 44, or the frequency of updates at data source 22. Cache manager 30 may also use a combination of criteria to determine an update schedule for data 40 in cache 14. For example, a frequency of updates to information at data source 22 may be greater than a frequency of requests for the information from a user of system 10. Thus, cache manager 30 may access request frequency rules 44 and update frequency rules 46 to determine an appropriate update schedule for data 40 in cache 14 by correlating the user request frequency with the data source 22 update frequency. Further, for example, the type of data at data source 22 may indicate a particular update frequency according to data attribute rules 42 while the actual frequency of updates to data source 22 may be different. Thus, cache manager 32 may evaluate a variety of information and rules 34 to determine a frequency for updating data 40 in cache 14.

Another example includes combining and/or correlating information from rules 42, 44 and 46 to determine a frequency for updating data 40 in cache 14. In this example, the type or attributes of data at data source 22 may indicate that the data at data source 22 comprise stock quote information. Thus, the type of data and the frequency of updates to the data at data source 22 may be relevant to determining a frequency of updating cache 14. For example, during active stock trading, the updates at data source 22 may be very frequent. Additionally, particular stocks may experience more quote requests than other stocks. Further, the quantity of users requesting quote information may be greater for some stocks than others. Thus, cache manager 30 may access each of rules 42, 44 and 46 to determine a frequency of updates to cache 14. For example, cache manager 30 may determine a greater update frequency for particular stock quote information based on the identity of the stock and/or the frequency of requests for a quote for particular stocks. Additionally, the frequency of updates to cache 14 may be increased or decreased at different periods throughout the day as stock trading increases, decreases, or ceases, and as requests for information from users varies.

Cache manager 30 may also be configured to automatically purge data 40 from cache 14 in response to predetermined conditions. For example, as the frequency of updates to data source 22 increases, cache manager 30 may determine to automatically purge data 40, thereby alleviating an operation comparing data 40 stored in cache 14 with newly obtained information from data source 22. Thus, update frequency rules 46 may comprise information associated with a predetermined frequency limit such that if the update frequency to data source 22 exceeds the limit, cache manager 30 will automatically purge data 40 after presenting data 40 to a user.

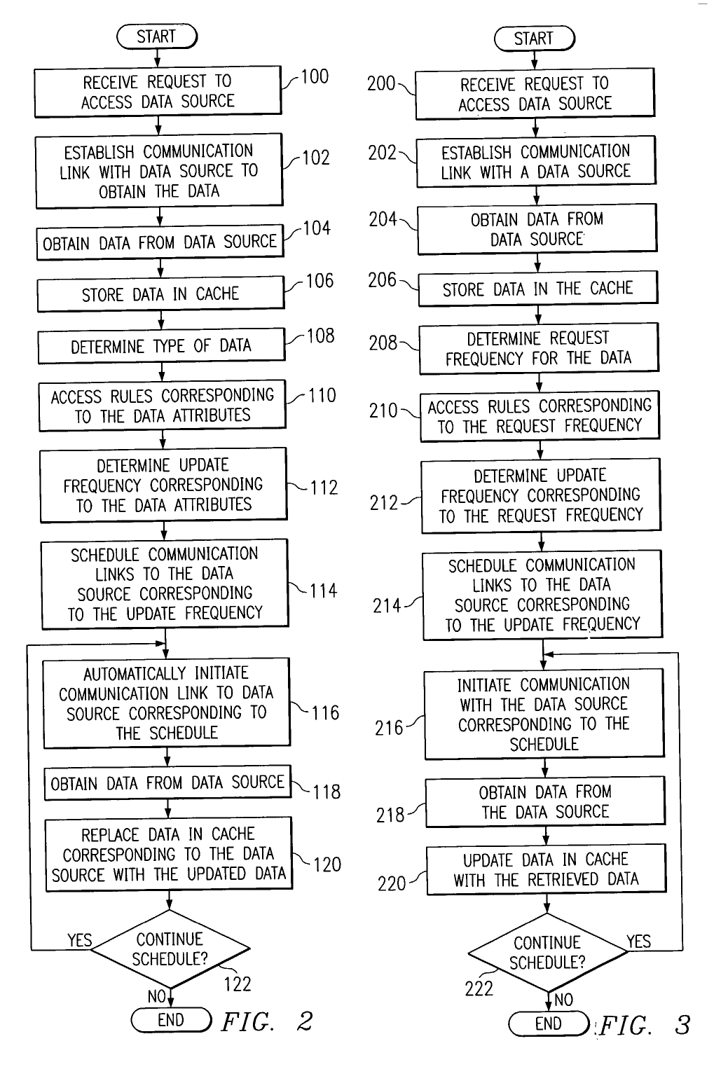

FIG. 2 is a flow chart illustrating an embodiment of a cache management method in accordance with an embodiment of the present invention. The method begins at block 100, where processor 12 receives a request from a user to access data source 22. At block 102, processor 12 establishes a communication link with data source 22 via network 20 to obtain the requested information from data source 22. At block 104, processor 12 obtains the information from data source 22. At block 106, processor 12 stores the obtained information as data 40 within cache 14 and provides the requested information to the user.

At block 108, cache manager 30 determines the type and/or attributes of information stored in cache 14 as data 40. At block 110, cache manager 30 accesses data attribute rules 42 corresponding to the type and/or attributes of data 40 stored within cache 14. At block 112, cache manager 30 determines an update frequency for data 40 stored in cache 14 corresponding to the type and/or attributes of data 40.

At block 114, scheduler 32 automatically schedules communication links to data source 22 to retrieve information for updating data 40 within cache 14 corresponding to the update frequency determined at block 112. At block 116, scheduler 32 automatically initiates a communication link with data source 22 corresponding to the update frequency schedule. At block 118, information is obtained from data source 22. At block 120, data 40 within cache 14 is replaced with updated information obtained from data source 22. Alternatively, the information obtained from data source 22 may be compared to data 40 in cache 14 and “stale” information in cache 14 may be replaced with the updated information. At decisional block 122, a determination is made whether continued scheduling of communication links to data source 22 is indicated. If additional communication links to data source 22 for updating data 40 within cache 14 is indicated, the method returns to block 116.

FIG. 3 is a flow chart illustrating another embodiment of a cache management method in accordance with the present invention. The method begins at block 200 where processor 12 receives a request from a user to access data source 22. At block 202, processor 12 establishes a communication link with data source 22 via network 20. At block 204, processor 12 obtains data 40 from data source 22 and at block 206 stores the information as data 40 within cache 14.

At block 208, cache manager 30 determines a frequency of requests for information from data source(s) 22 by at least one user. For example, as described above, cache manager 30 may monitor access to information of data source(s) 22 over a predetermined time period to establish a frequency of requests to access the information from data source(s) 22. At block 210, cache manager 30 accesses request frequency rules 44 corresponding to the determined frequency of user requests for information from data source(s) 22. At block 212, cache manager 30 determines an update frequency for data 40 within cache 14 corresponding to the frequency of user requests to access the information of data source(s) 22.

At block 214, scheduler 32 automatically schedules communication links to data source 22 to retrieve information for updating data 40 within cache 14 corresponding to the update frequency determined at block 212. At block 216, scheduler 32 automatically initiates a communication link with data source(s) 22 corresponding to the update frequency schedule. At block 218, information is obtained from data source(s) 22. At block 220, data 40 within cache 14 is replaced or otherwise updated with information obtained from data source(s) 22. At decisional block 222, a determination is made whether continued scheduling of communication links to data source(s) 22 is indicated. If additional communication links to data source(s) 22 for updating data 40 within cache 14 is indicated, the method returns to block 216.

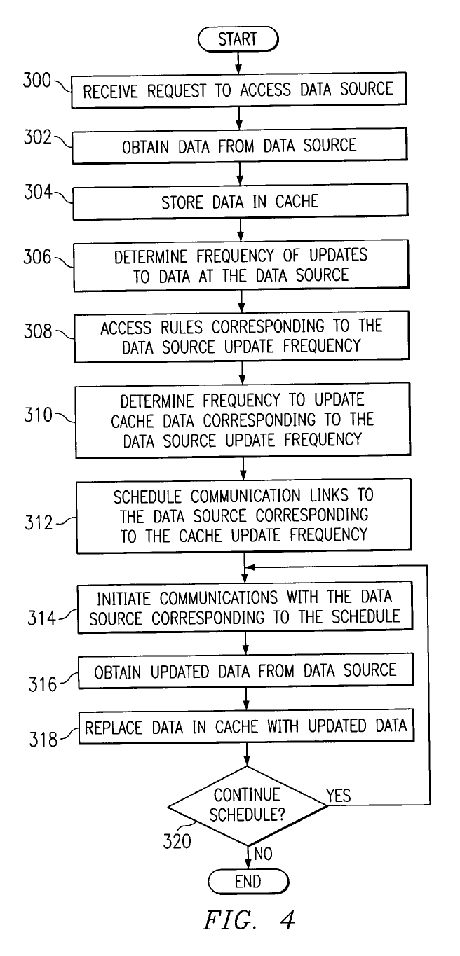

FIG. 4 is a flow chart illustrating another embodiment of a cache management method in accordance with the present invention. The method begins at block 300, where processor 12 receives a request to access data source 22. At block 302, processor 12 obtains information from data source 22 via network 20. At block 304, processor 12 stores information retrieved from data source 22 as data 40 in cache 14.

At block 306, cache manager 30 determines a frequency of updates to the information located at data source 22. At block 308, cache manager 30 accesses update frequency rules 46. At block 310, cache manager 30 determines a frequency for updating data 40 within cache 14 corresponding to the frequency of updates to information at data source 22.

At block 312, scheduler 32 automatically schedules communication links to data source 22 to retrieve information for updating data 40 within cache 14 corresponding to the update frequency determined at block 310. At block 314, scheduler 32 automatically initiates a communication link with data source 22 corresponding to the update frequency schedule. At block 316, information is obtained from data source 22. At block 318, data 40 within cache 14 is replaced or otherwise updated with information obtained from data source 22. At decisional block 320, a determination is made whether continued scheduling of communication links to data source 22 is indicated. If additional communication links to data source 22 for updating data 40 within cache 14 is indicated, the method returns to block 314.

Thus, embodiments of system 10 of the present invention automatically update information stored in a cache memory according to a variety of types of information or rules. It should be understood that in the described methods, certain steps may be omitted, combined, or accomplished in a sequence different than depicted in FIGS. 2-4. Also, it should be understood that the methods depicted may be altered to encompass any of the other features or aspects of the invention as described elsewhere in the specification. For example, as described above, one or more criteria may be evaluated by cache manager 30 to determine an update frequency for information stored in cache 14. Additionally, cache manager 30 may be used to monitor requests for information from a plurality of users to determine an update frequency for cache 14 as well as determine update frequencies for a plurality of data sources 22.

What is claimed is:

1. A cache management system, comprising:
a cache adapted to store data corresponding to a data source; and
a cache manager adapted to access a set of rules to determine a frequency for automatically updating the data in the cache, the cache manager adapted to automatically communicate with the data source to update the data in the cache corresponding to the determined frequency.

2. The system of claim 1, wherein the set of rules comprises data attribute rules having information associated with attributes of the data.

3. The system of claim 1, wherein the cache manager is adapted to automatically update the data in the cache corresponding to attributes of the data.

4. The system of claim 1, wherein the set of rules comprises request frequency rules having information associated with a request frequency for the data.

5. The system of claim 1, wherein the cache manager is adapted to automatically update the data in the cache corresponding to a frequency of user requests for the data.

6. The system of claim 1, wherein the set of rules comprises update frequency rules having information associated with an update frequency at the data source.

7. The system of claim 1, wherein the cache manager is adapted to automatically update the data in the cache corresponding to a frequency of updates at the data source.

8. The system of claim 1, further comprising a scheduler adapted to automatically schedule a communication link with the data source corresponding to the frequency.

9. The system of claim 1, wherein the cache manager is adapted to automatically purge the data from the cache if a frequency of updates at the data source exceeds a predetermined frequency limit.

10. The system of claim 1, wherein the cache manager is adapted to automatically update the data in the cache based on an update frequency at the data source and a frequency of user requests for the data.

11. A method for cache management, comprising:
storing data associated with a data source in a cache;
accessing a set of rules to determine a frequency for automatically updating the data in the cache;
automatically initiating communications with the data source corresponding to the determined frequency; and
automatically updating the data in the cache corresponding to the determined frequency.

12. The method of claim 11, wherein accessing a set of rules comprises accessing data attribute rules having information associated with attributes of the data.

13. The method of claim 11, further comprising determining the frequency for updating the data in the cache corresponding to the attributes of the data.

14. The method of claim 11, wherein accessing a set of rules comprises accessing request frequency rules having information associated with a frequency of requests for the data.

15. The method of claim 11, further comprising determining the frequency for updating the data in the cache corresponding to the frequency of user requests for the data.

16. The method of claim 11, wherein accessing a set of rules comprises accessing update frequency rules having information associated with a frequency of updates at the data source.

17. The method of claim 11, further comprising determining the frequency for updating the data in the cache corresponding to a frequency of updates at the data source.

18. The method of claim 11, further comprising automatically purging the data from the cache if an update frequency at the data source exceeds a predetermined frequency limit.

19. The method of claim 11, further comprising automatically scheduling a communication link with the data source corresponding to the determined frequency.

20. A cache management system, comprising:
means for storing data in a cache;
means for automatically determining a frequency for updating the data in the cache;
means for automatically initiating communications with the data source corresponding to the determined frequency; and
means for automatically updating the data in the cache corresponding to the determined frequency.

21. The system of claim 20, wherein the means for determining a frequency comprises means for determining a frequency for updating the data in the cache corresponding to attributes of the data.

22. The system of claim 20, wherein the means for determining a frequency comprises means for determining a frequency for updating the data in the cache corresponding to a frequency of updates at a data source.

23. The system of claim 20, wherein the means for determining a frequency comprises means for determining a frequency for updating the data in the cache corresponding to a frequency of user requests for the data.

24. The system of claim 20, further comprising means for automatically scheduling a communication link with a data source corresponding to the determined frequency.

25. The system of claim 20, further comprising means for automatically purging the data from the cache if a frequency of updates at a data source exceeds a predetermined frequency limit.

26. The system of claim 20, wherein the means for determining a frequency comprises means for determining a frequency for updating the data in the cache based on an update frequency at a data source and a frequency of user requests for the data.

27. A cache management system, comprising:
a cache adapted to store data corresponding to a data source;
a cache manager adapted to automatically determine a frequency for updating the data stored in the cache; and
a scheduler adapted to automatically schedule a communication link with the data source corresponding to the determined frequency.

28. The system of claim 27, wherein the cache manager is adapted to determine the frequency using information associated with attributes of the data.

29. The system of claim 27, wherein the cache manager is adapted to determine the frequency using information associated with a frequency of user requests for the data.

30. The system of claim 27, wherein the cache manager is adapted to determine the frequency using information associated with a frequency of updates at the data source.

31. The system of claim 27, wherein the cache manager is adapted to automatically purge the data from the cache if a frequency of updates at the data source exceeds a predetermined frequency limit.

32. The system of claim 27, wherein the cache manager is adapted to determine the frequency based on an update frequency at the data source and a frequency of user requests for the data.

33. The system of claim 27, further comprising a set of attribute rules accessible by the cache manager, the attribute rules comprising information associated with attributes of the data for determining the update frequency.

34. The system of claim 27, further comprising a set of request frequency rules accessible by the cache manager, the request frequency rules comprising information associated with a user request frequency for the data for determining the update frequency.

35. The system of claim 27, further comprising a set of update frequency rules accessible by the cache manager, the update frequency rules comprising information associated with a frequency of updates at the data source for determining the update frequency.
